(19) United States
(12) Patent Application Publication
(10) Pub. No.: US 2007/0171528 A1
(43) Pub. Date: Jul. 26, 2007

(54) Polarized wave coupling optical isolator

(76) Inventors: Shohei Abe, Shizuoka (JP); Tomokazu Imura, Shizuoka (JP); Akihiro Masuda, Shizuoka (JP); Kazuhide Kubo, Shizuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/727,514

(22) Filed: Mar. 27, 2007

Related U.S. Application Data
(63) Continuation of application No. 11/280,281, filed on Nov. 17, 2005.
Application No. 11/280,281 is a continuation of application No. 10/214,743, filed on Aug. 9, 2002, now abandoned.

(30) Foreign Application Priority Data
Aug. 10, 2001 (JP) 2001-244741

(51) Int. Cl. G02B 27/28

(52) U.S. Cl. 359/495

(57) ABSTRACT

A polarized wave coupling optical isolator comprises a plane-parallel birefringent element for optical path control, which is provided to control an optical path according to a polarizing direction, a plane-parallel birefringent element for coupling and splitting, which is provided with a certain interval from the birefringent element for optical path control to couple lights of different optical paths having polarizing directions set orthogonal to each other, and to split lights of the same optical path, a nonreciprocal portion provided between the birefringent element for optical path control and the birefringent element for coupling and splitting, and constructed by including a combination of 45° Faraday rotator and a linear phasor for rotating a plane of polarization by 45°, two input ports installed on the birefringent element side for optical path control, and an output port installed on the birefringent element side for coupling and splitting.

### CROSS-REFERENCE TO RELATED APPLICATIONS

This application is a continuation of U.S. application Ser. No. 10/214,743, filed Aug. 9, 2002, which claims priority based on Japanese Patent Application No. 2001-244741 filed on Aug. 10, 2001, which is herein incorporated by reference.

### BACKGROUND OF THE INVENTION

1. Field of the Invention

The present invention relates to an optical device having both a polarized wave coupling function and an optical isolator function. More specifically, the present invention relates to a polarized wave coupling optical isolator constructed by combining a plurality of parallel and planar birefringent elements with a Faraday rotator. This polarized wave coupling optical isolator is useful, for example, as an optical device for increasing power of an excitation light incident on an optical fiber amplifier.

2. Description of the Related Arts

In long-distance optical communications, as various factors cause gradual attenuation of a signal light transmitted through an optical fiber, the signal light must be amplified at proper intervals. An optical fiber amplifier has recently been used for such amplification of the signal light. This is an optical device where an optical fiber added with a rare earth element such as erbium is incident with a combined excitation light from a semiconductor laser as an excitation light source and a signal light, and amplifier the signal light based on stimulated emission transition generated between energy levels in a core of the optical fiber. Higher power of the excitation light has been demanded to widen intervals of installing optical fiber amplifiers, i.e., relaying intervals on transmission line. Thus, two excitation lights have been coupled to increase and supply optical power. Since the semiconductor laser used as the excitation light source emits almost linear polarized waves, an optical polarized wave coupler for coupling two linear polarized waves has been used as an optical coupler.

As a conventional optical polarized wave coupler, a construction using a polarization split prism similar to that shown in FIG. 9 is available. This optical coupler is constructed in such a manner that a fiber collimator 12a combining a single-core ferrule 10a having a polarization maintaining fiber with a lens 11a, and a fiber collimator 12b similarly combining a single-core ferrule 10b with a lens 11b are arranged to make lights incident on a polarization split prism 13 with incident directions varied by 90°, and a light coupled by a polarization split film 14 is connected to an optical fiber of a single-core ferrule 16 by a collimator lens 15. A P polarized light incident from one fiber collimator 12a is transmitted through the polarization split film 14, and an S polarized light incident from the other collimator 12b is reflected on the polarization split film 14. Thus, the P and S polarized lights are coupled on the polarization split film 14.

Here, the semiconductor laser (not shown) as the light source becomes unstable in operation if there is a reflected return light. Normally, therefore, optical isolators 17a and 17b are arranged on both input sides of the optical polarized wave coupler to block return lights. In practice, each of the optical isolators 17a and 17b comprises a combination of a polarizer, Faraday rotator, an analyzer and the like.

In the conventional optical polarized wave coupler of the above-described constitution, since the polarization split prism 13 disposed in the central portion includes triangle prisms joined together through the polarization split film (multilayer film) 14, adhesive is used in an optical path. However, because of a risk that the adhesive in the optical path may be burned out or deteriorated by an incident light, there is a limit to optical power to be entered, and accordingly to optical power to be outputted, making it impossible to satisfy a higher power demand of the excitation light source for the optical amplifier. If characteristic deterioration occurs, there is a possibility that the entire system may stop.

Further, in the conventional optical polarized wave coupler of the above-described constitution, so-called T-shaped arrangement is employed, where two input ports and one output port are positioned in three directions. Accordingly, not only is the device enlarged, but also wide installing space is necessary in the system including fiber routing space. Moreover, since the optical isolators 17a and 17b must be installed in both input ports, there was a problem that the number of components is increased, thus requiring a larger installing space.

### SUMMARY OF THE INVENTION

One object of the present invention is to provide a polarized wave coupling optical isolator having both a polarized wave coupling function and an optical isolator function, capable of satisfying a demand for higher optical power, and enabling miniaturization and cost reduction to be carried out.

In order to achieve the foregoing and other objects, in accordance with an aspect of the present invention, a polarized wave coupling optical isolator comprises a plane-parallel birefringent element for optical path control, which is provided to control an optical path according to a polarizing direction, a plane-parallel birefringent element for coupling and splitting, which is provided at a certain interval from the birefringent element for optical path control to couple lights of different optical paths having polarizing directions set orthogonal to each other, and to split lights of the same optical path, a nonreciprocal portion provided between the birefringent element for optical path control and the birefringent element for coupling and splitting, and including a combination of 45° Faraday rotator and a linear phasor for rotating a plane of polarization by 45°, two input ports installed on the birefringent element side for optical path control, and an output port installed on the birefringent element side for coupling and splitting. In this case, in a forward direction, polarized incident lights having polarizing directions orthogonal to each other, respectively entered from the two input ports, are coupled, and outputted to the output port. In a reverse direction, a return light from the output port is prevented from being connected to the two input ports.

In accordance with another aspect of the present invention, a polarized wave coupling optical isolator comprises a plane-parallel birefringent element for optical path control, which is provided to control an optical path according to a polarizing direction, a coupling and splitting device including two plane-parallel birefringent elements having optical axes-orthogonal to each other when seen from a direction of an optic axis, which is provided at certain interval from the birefringent element for optical path control to couple lights of different optical paths having polarizing directions set orthogonal to each other, and to split lights of the same optical path, a Faraday rotator provided between the birefringent element for optical path control and the coupling and splitting device, two input ports installed on the birefringent element side for optical path control, and an output port installed on the birefringent element side provided in a rear stage of the coupling and splitting device. In this case, in a forward direction, polarized incident lights having polarizing directions orthogonal to each other respectively entered from the two input ports, are coupled, and outputted to the output port. In a reverse direction, a return light from the output port is prevented from being connected to the two input ports.

In accordance with another aspect of the present invention, a polarized wave coupling optical isolator comprises first and second plane-parallel birefringent elements for optical path control, which are provided to control an optical path according to a polarizing direction, a plane-parallel birefringent element for coupling and splitting, which is provided at certain interval from the first and second birefringent elements for optical path control to couple lights of different optical paths having polarizing directions set orthogonal to each other, and to split lights of the same optical path, first and second nonreciprocal portions provided between the first and second birefringent elements for optical path control, and between the second birefringent element for optical path control and the birefringent element for coupling and splitting, each of the nonreciprocal portions including a 45° Faraday rotator and a linear phasor for rotating a plane of polarization by 45°, two input ports installed on the first birefringent element side for optical path control, and an output port installed on the birefringent element side for coupling and splitting. In this case, in a forward direction, polarized incident lights having polarizing directions orthogonal to each other, respectively entered from the two input ports, are coupled, and outputted to the output port. In a reverse direction, a return light from the output port is prevented from being connected to the two input ports.

In accordance with yet another aspect of the present invention, a polarized wave coupling optical isolator comprises first and second plane-parallel birefringent elements for optical path control, which are provided to control an optical path according to a polarizing direction, a plane-parallel birefringent element for coupling and splitting, which is provided at certain interval from the first and second birefringent elements for optical path control to couple lights of different optical paths having polarizing directions set orthogonal to each other, and to split lights of the same optical path, Faraday rotators respectively provided between the first and second birefringent elements for optical path control, and between the second birefringent element and the birefringent element for coupling and splitting, two input ports installed on the first birefringent element side for optical path control, and an output port installed on the birefringent element side for coupling and splitting. In this case, in a forward direction, polarized incident lights having polarizing directions orthogonal to each other, respectively entered from the two input ports, are coupled, and outputted to the output port. In a reverse direction, a return light from the output port is prevented from being connected to the two input ports.

### BRIEF DESCRIPTION OF THE DRAWINGS

FIG. 1 is a component arrangement view showing a polarized wave coupling optical isolator according to an embodiment of the present invention;

FIGS. 2A and 2B are explanatory views, each showing an optical path and a polarizing direction in the optical isolator of FIG. 1;

FIG. 3 is a component arrangement view showing a polarized wave coupling optical isolator according to another embodiment of the present invention;

FIGS. 4A and 4B are explanatory views, each showing an optical path and a polarizing direction in the optical isolator of FIG. 3;

FIG. 5 is a component arrangement view showing a polarized wave coupling optical isolator according to yet another embodiment of the present invention;

FIGS. 6A and 6B are explanatory views, each showing an optical path and a polarizing direction in the optical isolator of FIG. 5;

FIG. 7 is a component arrangement view showing a polarized wave coupling optical isolator according to further embodiment of the present invention;

FIGS. 8A and 8B are explanatory views, each showing an optical path and a polarizing direction in the optical isolator of FIG. 7; and

FIG. 9 is an explanatory view showing an example of a conventional art.

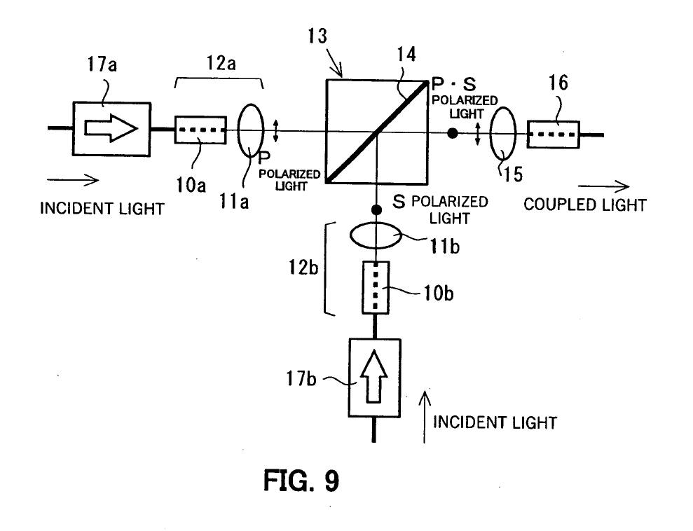

### DESCRIPTION OF THE PREFERRED EMBODIMENTS

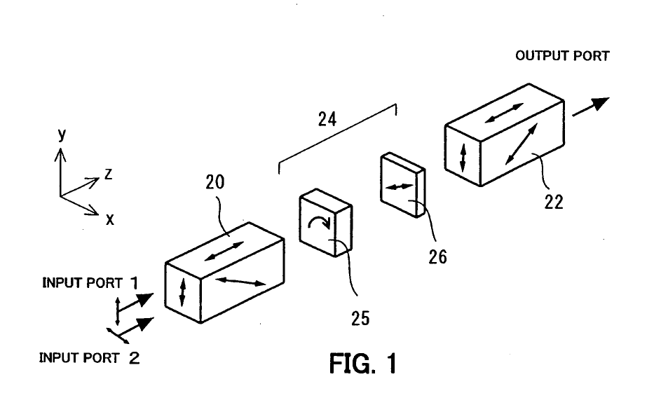

FIG. 1 is a component arrangement view showing a polarized wave coupling optical isolator according to an embodiment of the present invention. An arrow in each optical component indicates a direction of an optic axis or Faraday rotation. For easier explanation, the following coordinate axis is set. An arranging direction of an optical component (optic axis) is set as a z direction (depth direction in the drawing), and two directions orthogonal to the z axis are respectively set as an x direction (horizontal direction in the drawing) and a y direction (vertical direction in the drawing). For a rotational direction, a clockwise direction seen from the z direction is set as a plus side.

A plane-parallel birefringent element 20 for optical path control, and a plane-parallel birefringent element 22 for coupling and splitting are installed at a certain interval: the former being provided to control an optical path according to a polarizing direction, and the latter to couple lights of different optical paths, in which polarizing directions are orthogonal to each other, to split lights of the same optical path. Here, the “plane-parallel” type means a shape, in which planes of incidence and emission are parallel to each other (plane of incidence need not be strictly vertical to an incident light), and includes not only a plane-parallel shape but also a parallelogram block shape, a rectangular parallelepiped shape, and the like. Hereinafter, in each of the embodiments of the present invention, rectangular parallelepiped rutile crystals are used as the birefringent elements 20 and 22. The birefringent element for optical path control and the birefringent element for coupling and splitting may be the same elements. However, the arrangement directions of them are different to each other. In both birefringent elements, optical axes seen from the z direction are parallel to the y axis, while optical axes in a yz plane are tilted in opposite directions to form a V-shape.

A nonreciprocal portion 24 is provided between the birefringent element 20 for optical path control and the birefringent element 22 for coupling and splitting. This nonreciprocal portion 24 includes a combination of 45° Faraday rotator 25, and a linear phasor 26 for rotating a plane of polarization by 45°. The linear phasor 26 is a ½ wavelength plate having an optic axis tilted by −22.50° with respect to the x axis to rotate a polarizing direction by 45°. The arraying order of the 45° Faraday rotator 25 and the linear phasor 26 may be reversed.

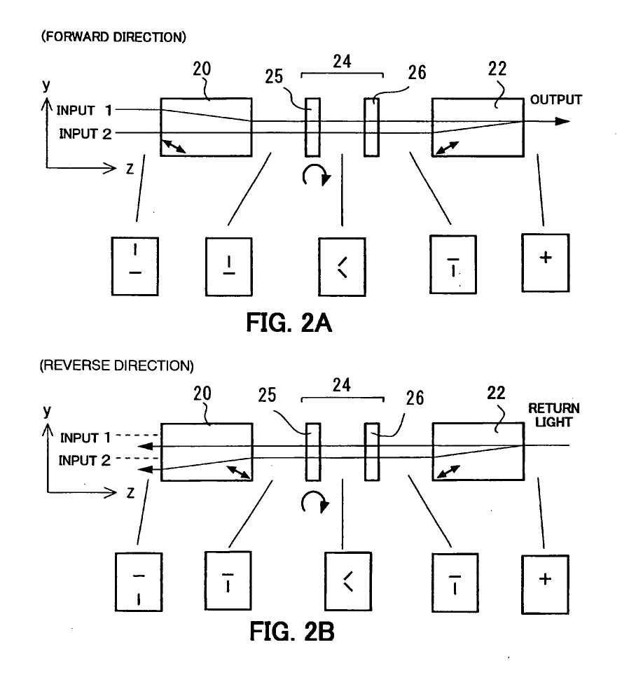

Each of FIGS. 2A and 2B shows an optical path on a yz plane (side surface) and a polarizing direction seen from a direction of an optic axis (±z direction) in the polarized wave coupling optical isolator. FIG. 2A represents a forward direction, while FIG. 2B represents a reverse direction. Positions of two input ports are substantially the same in the x direction, and different in the y direction. An incident light from the upper input port 1 on the birefringent element for optical path control is set as an extraordinary light, and an incident light from the lower input port 2 is set as an ordinary light.

===Forward Direction: see FIG. 2A===

A light incident from the input port 1 in the z direction is an extraordinary light for the birefringent element 20 for optical path control. Thus, the light is refracted in a −y direction to change an optical path, a polarizing direction is rotated by +45° at the Faraday rotator 25, and the polarizing direction is further rotated by +45° because the ½ wavelength plate as the linear phasor 26 has a characteristic of changing a polarizing direction of an incident light to be symmetrical to its optic axis. That is, the polarizing direction is rotated by a total of 90° at the nonreciprocal portion 24. This light becomes an ordinary light for the birefringent element 22 for coupling and splitting, and thus it is traveled straight ahead as is, and outputted from the output port. On the other hand, a light incident from the input port 2 in the z direction is an ordinary light for the birefringent element 20 for optical path control, and thus it is traveled ahead as is, a polarizing direction is rotated by +45° at the Faraday rotator 25, and further rotated by +45° at the linear phasor 26. This light becomes an extraordinary light for the birefringent element 22 for coupling and splitting, and thus it is refracted in a +y direction to change an optical path, and outputted from the output port. Therefore, in the forward direction, polarized waves entered from the two different input ports are coupled together, and connected to the output port (Polarized wave coupling function).

===Reverse Direction: see FIG. 2B===

A return light, a light traveling in a −z direction, from the output port by reflection travels straight ahead as an ordinary light through the birefringent element 22 for coupling and splitting. As an extraordinary light, the return light is refracted, and split in a −y direction. A polarizing direction is rotated by −45° at the linear phasor 26, and rotated by +45° at the Faraday rotator 25 Accordingly, no change occurs in the polarizing direction at the nonreciprocal portion 24. A light of the upper optical path remains as an ordinary light for the birefringent element 20 for optical path control, and thus it travels straight ahead as is, not being connected to either of the two input ports. A light of the lower optical path is an extraordinary light for the birefringent element 20 for optical path control, and thus it is refracted in the −y direction to change an optical path, not being connected to either of the two input ports. Therefore, in the reverse direction, the return light from the output port does not connect to the input ports (Optical isolator function).

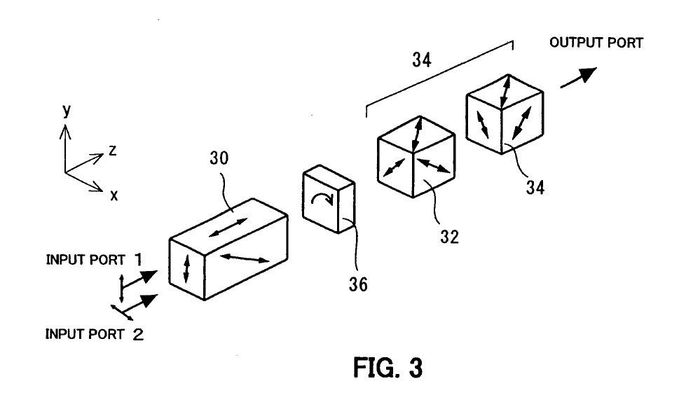

FIG. 3 is a component arrangement view showing a polarized wave coupling optical isolator according to another embodiment of the present invention. A plane-parallel birefringent element 30 for optical path control, and a coupling and splitting device 34 are installed at a certain interval. The element 30 is provided to control an optical path according to a polarizing direction. The device 34 has a combination of two plane-parallel birefringent elements 32 and 33, in which optical axes thereof are orthogonal to each other when seen from a direction of an optic axis, and being provided to couple lights of different optical paths having polarizing directions set orthogonal to each other, and to split lights of the same optical path. In the birefringent element 30 for optical path control, an optic axis seen from a z direction is parallel to a y axis, while optical axes in a yz plane are tilted in a −y direction. The two birefringent elements 32 and 33 constituting the coupling and splitting device 34 may be the same ones. However, an optic axis of one of the two elements is tilted by −45° with respect to an x axis when seen from the z direction, and the other by +45°. Optical axes in an xz plane are set to be tilted in a −x direction, and they are respectively set to be tilted in a −y direction and a +y direction in a yz plane. Z-direction lengths of the birefringent elements 32 and 33 constituting the coupling and splitting device 34 are set shorter than that of the birefringent element 30 for optical path control in view of a changing amount of an optical path. Then, 45° Faraday rotator 36 is provided between the birefringent element 30 for optical path control and the coupling and splitting device 34.

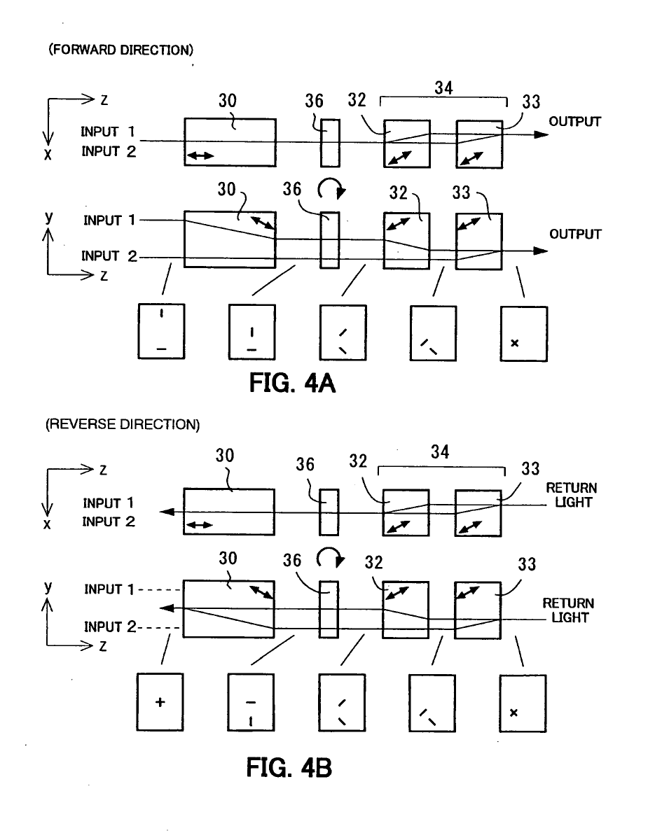

Each of FIGS. 4A and 4B shows an optical path on an xz plane (plane surface), an optical path on a yz plane (side surface), and a polarizing direction seen from a direction of an optic axis (±z direction) in the polarized wave coupling optical isolator. FIG. 4A represents a forward direction, while FIG. 4B represents a reverse direction. Positions of two input ports are substantially the same in the x direction, and different in the y direction. A light incident from the upper input port 1 on the birefringent element 30 for optical path control is set as an extraordinary light, and a light incident from the lower input port 2 is set as an ordinary light.

===Forward Direction: see FIG. 4A===

A light incident from the input port 1 in the z direction is an extraordinary light for the birefringent element 30 for optical path control. Thus, the light is refracted in a −y direction to change an optical path, and a polarizing direction is rotated by +45° at the Faraday rotator 36. This light becomes an extraordinary light for the first birefringent element 32 of the coupling and splitting device 34, and thus it is refracted in a −x−y direction to change an optical path. The light becomes an ordinary light for the second birefringent element 33, and thus it travels straight ahead as is, and outputted from the output port. On the other hand, a light incident from the input port 2 in the z direction is an ordinary light for the birefringent element 30 for optical path control, and thus it travels ahead as is, and a polarizing direction is rotated by +45° at the Faraday rotator 36. This light becomes an ordinary light for the first birefringent element 32 of the coupling and splitting device 34, and thus it travels ahead as is. The light becomes an extraordinary light for the second birefringent element 33, and thus it is refracted in a −x+y direction to change an optical path, and outputted from the output port. Therefore, in the forward direction, polarized waves entered from the two different input ports are coupled together, and connected to the output port (Polarized wave coupling function).

===Reverse Direction: see FIG. 4B===

A return light, a light traveling in a −z direction, from the output port due to reflection travels straight ahead as for an ordinary light through the two birefringent elements 33 and 32 of the coupling and splitting device 34. AS for an extraordinary light, the return light is refracted, and split in a ±y direction. A polarizing direction is rotated by +45° at the Faraday rotator 36. A light of the upper optical path is an ordinary light for the birefringent element 30 for optical path control, and thus it travels straight ahead as is, not being connected to either of the two input ports. A light of the lower optical path is an extraordinary light for the birefringent element 30 for optical path control, and thus it is refracted in the +y direction to change an optical path, and coupled but not connected to either of the two input ports. Therefore, in the reverse direction, the return light from the output port does not connect to the input ports (Optical isolator function).

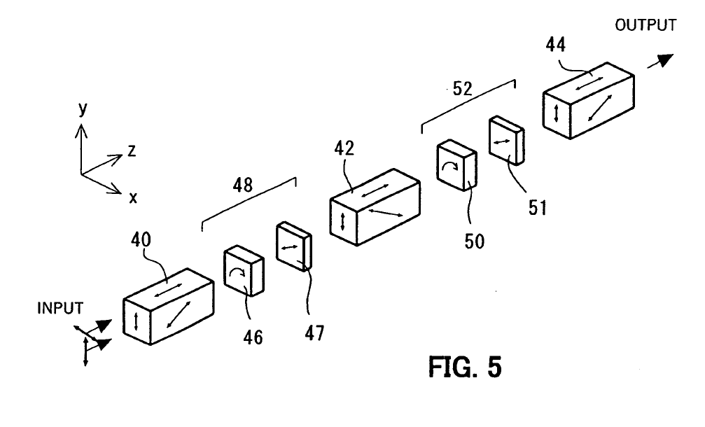

FIG. 5 is a component arrangement view showing a polarized wave coupling optical isolator according to another embodiment of the present invention. First and second plane-parallel birefringent elements 40 and 42 for optical path control, and a plane-parallel birefringent element 44 for coupling and splitting are installed with a certain interval. The elements 40 and 42 are provided to control an optical path according to a polarizing direction. The element 44 is provided to couple lights of different optical paths, in which polarizing directions are orthogonal to each other, and to split lights of the same optical path. Here, the first and second birefringent elements 40 and 42 for optical path control, and the birefringent element 44 for coupling and splitting may be the same one even though they are different in directions of arrangement. In all the birefringent elements 40, 42 and 44, their optical axes seen from a z direction are parallel to a y axis, while the optical axes in a yz plane are in a tilted relationship, in which a subsequent one is tilted in an opposite direction to the prior one.

A first nonreciprocal portion 48 is provided between the first and second birefringent elements 40 and 42 for optical path control: the nonreciprocal portion 48 including a combination of 45° Faraday rotator 46, and a linear phasor 47 for rotating a plane of polarization by 45°. A second nonreciprocal portion 52 is provided between the second birefringent element 42 for optical path control, and the birefringent element 44 for coupling and splitting: the nonreciprocal portion 52 including a combination of 45° Faraday rotator 50 and a linear phasor 51 for rotating a plane of polarization by 45°. The linear phasors 47 and 51 are both ½ wavelength plates each having an optic axis tilted by −22.50° with respect to the x axis to rotate a polarizing direction by 45°. The arraying order of the 45° Faraday rotator and the linear phasor in the nonreciprocal portion may be reversed.

As apparent from comparison of FIG. 5 with FIG. 1, a portion composed of the second birefringent element 42 for optical path control, the second nonreciprocal portion 52, and the birefringent element 44 for coupling and synthesizing, is similar to that of the embodiment shown in FIG. 1. In other words, the present embodiment includes the first nonreciprocal portion 48 and the first birefringent element 40 for optical path control added in the prior stage of the embodiment shown in FIG. 1.

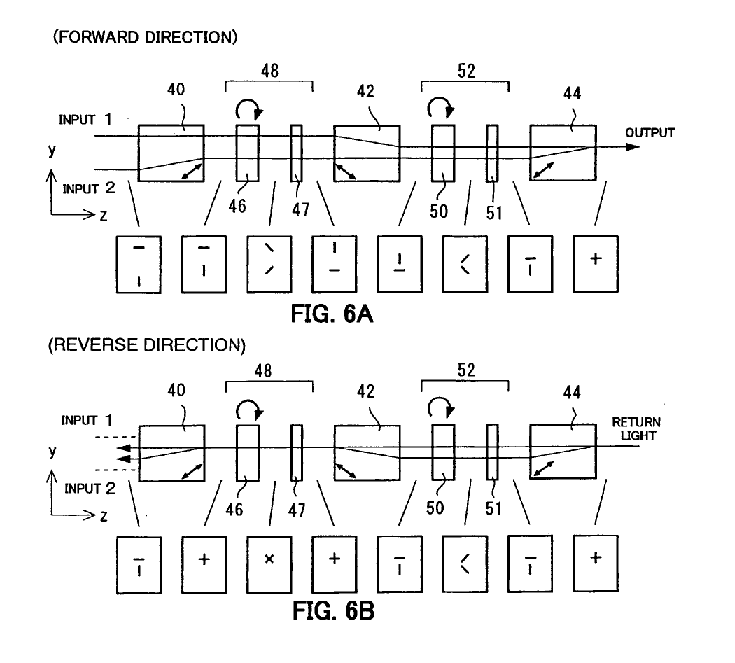

Each of FIGS. 6A and 6B shows an optical path on a yz plane (side surface) and a polarizing direction seen from a direction of an optic axis (±z direction) in the polarized wave coupling optical isolator. FIG. 6A represents a forward direction, while FIG. 6B represents a reverse direction. Positions of two input ports are substantially the same in an x direction, and different in a y direction. A light incident from the upper input port 1 on the birefringent element 40 for optical path control is set as an ordinary light, and a light incident from the lower input port 2 is set as an extraordinary light.

===Forward Direction: see FIG. 6A===

A light incident from the input port 1 in the z direction is an ordinary light for the first birefringent element 40 for optical path control. Thus, the light travels ahead as is, and a polarizing direction is rotated by 90° (rotated by +45° at the Faraday rotator 46, and further rotated by +45° at the linear phasor 47) at the first nonreciprocal portion 48. Then, the light becomes an extraordinary light for the second birefringent element 42 for optical path control, and thus it is refracted in a −y direction to change an optical path, and the polarizing direction is further rotated by 90° at the second nonreciprocal portion 52. This light becomes an ordinary light for the birefringent element 44 for coupling and splitting, and thus it travels straight ahead as is, and outputted from the output port. On the other hand, a light incident from the input port 2 in the z direction is an extraordinary light for the first birefringent element 40 for optical path control, and thus it is refracted in a +y direction to change an optical path, and a polarizing direction is rotated by 90° at the fist nonreciprocal portion 48. Then, the light is an ordinary light for the second birefringent element 42 for optical path control. Thus, the light travels ahead as is, and the polarizing direction is further rotated by 90° at the second nonreciprocal portion 52. The light becomes an extraordinary light for the birefringent element 44 for coupling and splitting, and thus it is refracted in the +y direction to change an optical path, and outputted from the output port. Therefore, in the forward direction, polarized waves entered from the two different input ports are coupled together, and connected to the output port (Polarized wave coupling function).

===Reverse Direction: see FIG. 6B===

A return light, a light traveling in a −z direction, from the output port due to reflection travels straight ahead as for an ordinary light through the birefringent element 44 for coupling and splitting. As for an extraordinary light, the return light is refracted, and split in a −y direction. The polarizing direction is not changed at the second nonreciprocal portion 52 (polarizing direction is rotated by −45° at the linear phasor 51, and rotated by +45° at the Faraday rotator 50). A light of the upper optical path is an ordinary light for the second birefringent element 42 for optical path control, and thus it travels straight ahead as is, and the polarizing direction is not changed at the first nonreciprocal portion 48. Accordingly, the light is maintained as the ordinary light for the first birefringent element 40 for optical path control, and thus it travels ahead as is, not being connected to either of the two input ports. A light of the lower optical path is an extraordinary light for the second birefringent element 42 for optical path control, and thus it is refracted in the +y direction to change an optical path, and a polarizing direction is not changed at the first nonreciprocal portion 48. Accordingly, the light is maintained as the extraordinary light for the first birefringent element 40 for optical path control, and thus the light is refracted in the −y direction to change an optical path, not being connected to either of the two input ports. Therefore, in the reverse direction, the return light from the output port does not connect to the input ports (Optical isolator function).

In this constitution, since the two nonreciprocal portions are arranged in series, the optical isolator substantially becomes a two stage type with greatly improved isolation.

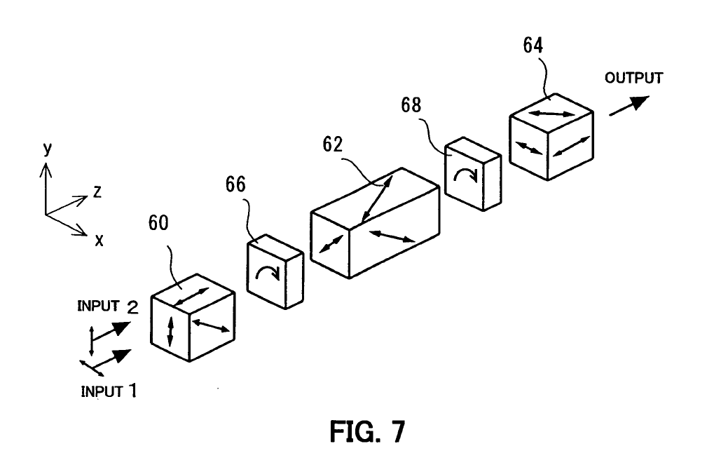

FIG. 7 is a component arrangement view showing a polarized wave coupling optical isolator according to yet another embodiment of the present invention. First and second plane-parallel birefringent elements 60 and 62 for optical path control, and a plane-parallel birefringent element 64 for coupling and splitting are installed at a certain interval. The elements 60 and 62 are provided to control an optical path according to a polarizing direction. The element 64 is provided to couple lights of different optical paths, in which polarizing directions are orthogonal to each other, and to split lights of the same optical path. In case of the first birefringent element 60 for optical path control, an optic axis seen from a z direction is parallel to a y axis, and an optic axis in a yz plane is tilted in a −y direction. In the case of the second birefringent element 62 for optical path control, an optic axis seen from the z direction is tilted by −45° with respect to an x axis, and optical axes in an xz plane and the yz plane are respectively tilted in −x and −y directions. In the case of the birefringent element 64 for coupling and splitting, an optic axis seen from the z direction is parallel to an x axis, and an optic axis in an xz plane is tilted in a +x direction. In view of a changing amount of an optical path, z-direction lengths of the first birefringent element 60 for optical path control and the birefringent element 64 for coupling and splitting are set shorter than that of the second refraction element 62 for optical path control. First and second 450 Faraday rotators 66, 68 are respectively provided between the first and second birefringent elements 60 and 62 for optical path control, and between the second birefringent element 62 for optical path control and the birefringent element 64 for coupling and splitting.

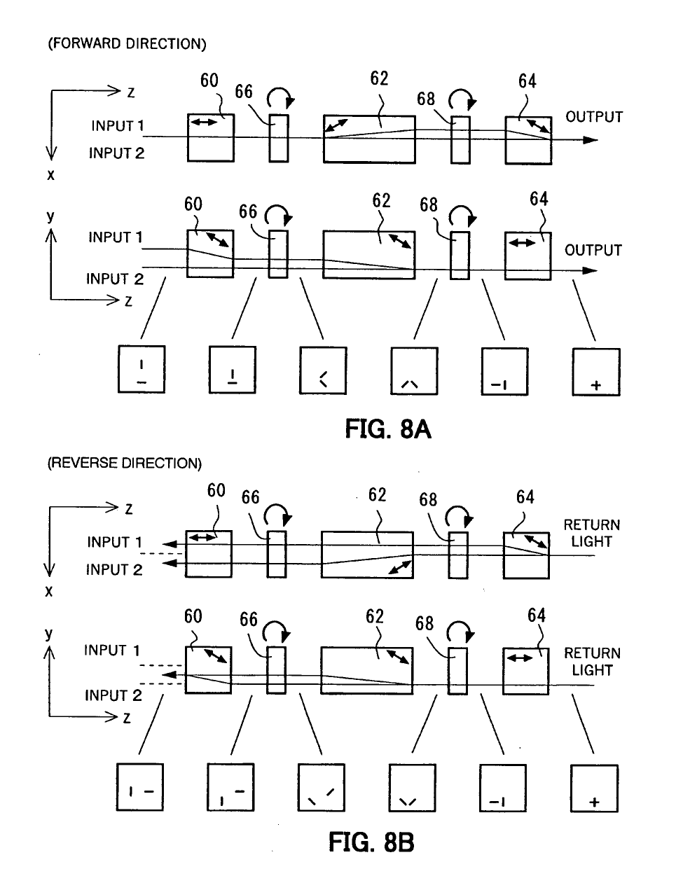

Each of FIGS. 8A and 8B shows an optical path on an xz plane (plane surface), an optical path on a yz plane (side surface), and a polarizing direction seen from a direction of an optic axis (±z direction) in the polarized wave coupling optical isolator. FIG. 8A represents a forward direction, while FIG. 8B represents a reverse direction. Positions of two input ports are substantially the same in the x direction, and different in the y direction. A light incident from the upper input port 1 on the first birefringent element 60 for optical path control is set as an extraordinary light, and a light incident from the lower input port 2 is set as an ordinary light.

===Forward Direction: see FIG. 8A===

A light incident from the input port 1 in the z direction is an extraordinary light for the first birefringent element 60 for optical path control. Thus, the light is refracted in a −y direction to change an optical path, and a polarizing direction is rotated by +45° at the first Faraday rotator 66. This light becomes an extraordinary light for the second birefringent element 62 for optical path control, and thus it is refracted in −x and −y directions to change an optical path, and the polarizing direction is further rotated by +45° at the second Faraday rotator 68. This light becomes an extraordinary light for the birefringent element 64 for coupling and splitting, and thus it is refracted in a +x direction to change an optical path, and outputted from the output port. On the other hand, a light incident from the input port 2 in the z direction is an ordinary light for the first birefringent element 60 for optical path control, and thus it travels ahead as is, and a polarizing direction is rotated by +45° at the first Faraday rotator 66. This light also becomes an ordinary light for the second birefringent element 62 for optical path control, and thus it travels ahead as is, and the polarizing direction is further rotated by +45° at the second Faraday rotator 68. The light becomes an ordinary light for the birefringent element 64 for coupling and splitting, and thus it travels ahead as is, and outputted from the output port. Therefore, in the forward direction, polarized waves entered from the two different input ports are coupled together, and connected to the output port (Polarized wave coupling function).

===Reverse Direction: see FIG. 8B===

A return light, a light traveling in a −z direction, from the output port by reflection trayels straight ahead as for an ordinary light through the birefringent element 64 for coupling and splitting. As for an extraordinary light, the return light is refracted, and split in a −x direction. A polarizing direction is rotated by +45° at the second Faraday rotator 68. A light of a right optical path is maintained as an ordinary light for the second birefringent element 62 for optical path control, and thus it travels ahead as is, and rotated by +45° at the second Faraday rotator 66. The light becomes an extraordinary light for the first birefringent element 60 for optical path control, and thus it is refracted in a +y direction, not a being connected to either of the two input ports. A light of a left side optical path is an extraordinary light for the second birefringent element 62 for optical path control, and thus it is refracted in a +x+y direction to change an optical path, and rotated by +45° at the second Faraday rotator 66. The light is an ordinary light for the first birefringent element 60 for optic path control, and thus it travels straight ahead as is, not being connected to either of the two input ports. Therefore, in the reverse direction, the return light from the output port does not connect to the input ports (Optical isolator function).

In this constitution, since the two Faraday rotators are arranged in series, the optical isolator substantially becomes a two stage type, thus having improved isolation.

As apparent from the foregoing, according to the polarized wave coupling optical isolator of this embodiment, since the polarized wave coupling function can be realized without providing any adhesive in the optical path, it is possible to satisfy a demand for higher optical power, and enhance reliability without any possibilities of characteristic deterioration and the like. Moreover, since the polarized wave coupling optical isolator of this embodiment also includes the optical isolator function, and inputs and outputs can be linearly arranged, it is possible to achieve miniaturization including fiber routing space, and reduce costs.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

1-6. (canceled)

7. A polarized wave coupling optical isolator comprising:
a first plane-parallel birefringent element shaped and arranged to control an optical path of beams of light based on a polarization direction of the beams of light;
a second plane-parallel birefringent element spaced apart from said first birefringent element, said second birefringent element being shaped and arranged to couple beams of light on different optical paths and having polarization directions orthogonal to each other, and being shaped and arranged to split beams of light on the same optical path;
a nonreciprocal element between said first birefringent element and said second birefringent element, said nonreciprocal element including a 45° Faraday rotator and a linear phasor for rotating a plane of polarization of beams of light passing therethrough by 45°;
two input ports at said first birefringent element for introducing two beams of light into said first birefringent element; and
an output port at said second birefringent element for emitting a beam of light from said second birefringent element;
wherein said first birefringent element, said second birefringent element, and said nonreciprocal element are shaped and arranged such that:
two separate beams of light having polarization directions orthogonal to each other and which simultaneously enter said two input ports, respectively, so as to travel from said first birefringent element to said second birefringent element are coupled and emitted from said output port as coupled beams of light; and
said coupled beams of light reflected back into said output port so as to travel in a direction from said second birefringent element toward said first birefringent element are prevented from being optically connected to either of said two input ports.

8. The polarized wave coupling optical isolator of claim 7, wherein each of said first birefringent element and said second birefringent element comprises a rutile crystal.

9. The polarized wave coupling optical isolator of claim 7, wherein said linear phasor comprises a ½ wavelength plate.

10. A polarized wave coupling optical isolator comprising:
a first plane-parallel birefringent element shaped and arranged to control an optical path of beams of light based on a polarizing direction of the beams of light;
a coupling and splitting device including a second plane-parallel birefringent element and a third plane-parallel birefringent element, said second plane-parallel birefringent element and said third plane-parallel birefringent element having optical axes orthogonal to each other when viewed along an optical axis, said coupling and splitting device being spaced apart from said first birefringent element, and being shaped and arranged to couple beams of light on different optical paths and having polarizing directions orthogonal to each other, and to split beams of light on the same optical path;
a Faraday rotator between said first birefringent element and said coupling and splitting device;
two input ports at said first birefringent element for introducing two beams of light into said first birefringent element; and
an output port at said coupling and splitting device for emitting a beam of light from said third birefringent element of said coupling and splitting device;
wherein said first birefringent element, said coupling and splitting device, and said Faraday rotator are shaped and arranged such that:
two separate beams of light having polarization directions orthogonal to each other and which simultaneously enter said two input ports, respectively, so as to travel from said first birefringent element to said coupling and splitting device are coupled and emitted from said output port as coupled beams of light; and
said coupled beams of light reflected back into said output port so as to travel in a direction from said coupling and splitting device toward said first birefringent element are prevented from being optically connected to either of said two input ports.

11. The polarized wave coupling optical isolator of claim 10, wherein each of said first birefringent element, said second birefringent element, and said third birefringent element comprises a rutile crystal.

12. The polarized wave coupling optical isolator of claim 10, wherein said linear phasor comprises a ½ wavelength plate.

13. A polarized wave coupling optical isolator comprising:
a first plane-parallel birefringent element shaped and arranged to control an optical path of beams of light based on a polarizing direction of the beams of light;
a second plane-parallel birefringent element shaped and arranged to control an optical path of beams of light based on a polarizing direction of the beams of light;
a third plane-parallel birefringent element spaced apart from said first birefringent element and said second birefringent element, said third birefringent element being shaped and arranged to couple beams of light on different optical paths and having polarizing directions orthogonal to each other, and to split beams of light on the same optical path;
a first set of nonreciprocal portions including a first nonreciprocal portion and a second nonreciprocal portion between said first birefringent element and said second birefringent element, said first set of nonreciprocal portions comprising a 45° Faraday rotator and a linear phasor operable to rotate a plane of polarization by 45°;
a second set of nonreciprocal portions including a third nonreciprocal portion and a fourth nonreciprocal portion between said second birefringent element and said third birefringent element, said second set of nonreciprocal portions comprising a 45° Faraday rotator and a linear phasor operable to rotate a plane of polarization by 45°;
two input ports at said first birefringent element for introducing two beams of light into said first birefringent element; and
an output port at said third birefringent element for emitting a beam of light from said third birefringent element;
wherein said first birefringent element, said second birefringent element, said third birefringent element, said first set of nonreciprocal portions, and said second set of nonreciprocal portions are shaped and arranged such that:
two separate beams of light having polarization directions orthogonal to each other and which simultaneously enter said two input ports, respectively, so as to travel from said first birefringent element to said third birefringent element are coupled and emitted from said output port as coupled beams of light; and
said coupled beams of light reflected back into said output port so as to travel in a direction from said third birefringent element toward said first birefringent element are prevented from being optically connected to either of said two input ports.

14. The polarized wave coupling optical isolator of claim 13, wherein each of said first birefringent element, said second birefringent element, and said third birefringent element comprises a rutile crystal.

15. The polarized wave coupling optical isolator of claim 13, wherein said linear phasor comprises a ½ wavelength plate.

16. A polarized wave coupling optical isolator comprising:
a first plane-parallel birefringent element shaped and arranged to control an optical path of beams of light based on a polarizing direction of the beams of light;
a second plane-parallel birefringent element shaped and arranged to control an optical path of beams of light based on a polarizing direction of the beams of light;
a third plane-parallel birefringent element spaced apart from said first birefringent element and said second birefringent element, said third birefringent element being shaped and arranged to couple beams of light on different optical paths and having polarizing directions orthogonal to each other, and to split beams of light on the same optical path;
a first Faraday rotator between said first birefringent element and said second birefringent element;
a second Faraday rotator between said second birefringent element and said third birefringent element;
two input ports at said first birefringent element for introducing two beams of light into said first birefringent element; and
an output port at said third birefringent element for emitting a beam of light from said third birefringent element;
wherein said first birefringent element, said second birefringent element, said third birefringent element, said first Faraday rotator, and said second Faraday rotator are shaped and arranged such that:
two separate beams of light having polarization directions orthogonal to each other and which simultaneously enter said two input ports, respectively, so as to travel from said first birefringent element to said third birefringent element are coupled and emitted from said output port as coupled beams of light; and
said coupled beams of light reflected back into said output port so as to travel in a direction from said third birefringent element toward said first birefringent element are prevented from being optically connected to either of said two input ports.

17. The polarized wave coupling optical isolator of claim 16, wherein each of said first birefringent element, said second birefringent element, and said third birefringent element comprises a rutile crystal.

18. The polarized wave coupling optical isolator of claim 16, wherein said linear phasor comprises a ½ wavelength plate.
